(19) United States
(12) Patent Application Publication
(10) Pub. No.: US 2005/0137292 A1
(43) Pub. Date: Jun. 23, 2005

(54) Adhesive composition

(75) Inventor: Peter Sibbett, Tacoma, WA (US)

Correspondence Address: BACON & THOMAS, PLLC, 625 SLATERS LANE, FOURTH FLOOR, ALEXANDRIA, VA, 22314, US

(73) Assignee: CAPSTONE ENGINEERING LTD., Gyeongnam (KR)

(21) Appl. No.: 10/865,823

(22) Filed: Jun. 14, 2004

(30) Foreign Application Priority Data
Dec. 23, 2003 (KR) 10-2003-0095230

(51) Int. Cl. C08L 63/00

(52) U.S. Cl. 523/400

(57) ABSTRACT

The present invention provides an adhesive composition comprising a main adhesive composed of 50 to 100% by weight of BPA epoxy resin, 0.5 to 5% by weight of a dispersant and 0.5 to 5% by weight of a fluidity adjusting agent as additives, and 0 to 50% by weight of a filler; and a curing agent composed of 15 to 50% by weight of polymeric amine, 1 to 99% by weight of amine-terminated reactive rubber and 0.5 to 5% by weight of an anti-settling agent as additives, 0.1 to 10% by weight of tertiary amine as a catalyst, and 0 to 60% by weight of a filler. The main adhesive component and the curing agent component are mixed in a ratio of 1:2 to 2:1 by weight. The adhesive comprising the adhesive composition of the present invention has superior adhesive force and peeling strength and thus exhibits very excellent adhesiveness in bonding an SMC board to PVC material or wood.

### BACKGROUND OF THE INVENTION

1. Field of Invention

The present invention relates to an adhesive composition, specifically, to an adhesive composition for bonding in inside and outside doors of buildings. More particularly, the present invention relates to an adhesive composition having improved adhesive force and peeling strength between sheet molding compound (SMC) material and wood or between the SMC material and polyvinyl chloride (PVC) material.

2. Description of the Prior Art

To bond one material to another material, an adhesive should be solidified after it is applied to the materials that in turn are brought into contact with each other. Therefore, an adhesive should be made of a polymer that is initially in a liquid phase and finally solidified not to be subjected to separation (i.e., with superior adhesive force) and breaking (i.e., with superior peeling strength).

Adhesives can be roughly classified into three types: adhesives composed of polymer solutions such as starches dissolved in water, gum dissolved in gasoline and vinyl polyacetates dissolved in thinners; adhesives composed of liquid-state monomers such as cyanoacrylate and bisacrylate which are subjected to polymerization after they are applied; and adhesives composed solid-state polymers which will be melted through heating to be applied.

Adhesives can also be classified into natural adhesives and synthetic polymer adhesives according to chemical structures. Among them, epoxy resin adhesives have been widely used for various industrial purposes due to high adhesive strength thereof.

As for adhesives composed of epoxy resin as a main component and polyamides as a curing agent, there is an advantage in that they have high strength in a cured state. However, there is a disadvantage in that they are brittle and thus the peeling strength thereof is very low in the cured state. Accordingly, if impact is exerted on or rapid temperature changes are repeated in two bonded materials with time, there is a problem in that the adhesion state therebetween is remarkably deteriorated.

Particularly, bisphenol-A (BPA) epoxy resin has good tensile adhesiveness for metal at room temperature, but has rapidly reduced peeling or adhesive strength at low temperature and lacks adhesiveness for hard plastics.

To overcome the disadvantages of such epoxy resin based adhesives, there has been suggested imparting elasticity to epoxy resin.

That is, epoxy resin has been replaced with nitrile butadiene rubber (NBR) modified epoxy resin, carboxyl-terminated butadiene acrylonitrile copolymer (CTBN) modified epoxy resin, or urethane modified epoxy resin. However, since there is a processing disadvantage in that such rubber modified epoxy resin should be modified with BPA based resin upon use thereof, production costs are increased and it is still difficult to obtain a desired level of peeling strength and improvement of adhesiveness at low temperature.

Inside or outside doors of buildings are generally made of steel or wood material. However, a steel door has a disadvantage in that it is heavy and has low durability due to corrosion. Meanwhile, although a wooden door is relatively light compared with the steel door, it still has limitations in view of scratchability and durability. Accordingly, there has been developed a new type of door made of composite materials comprising plastics and wood or other plastics, for example, a door made of sheet molding compound (SMC) material. In this case, the adhesive force between different materials has become a very important issue in view of the durability of such a door.

However, there is a problem in that the existing epoxy resin based adhesives have very low adhesive strength when they are used to bond SMC material to wood or polyvinyl chloride (PVC) material, and they should be used in excessive amounts to maintain adhesive force.

### SUMMARY OF THE INVENTION

Accordingly, the present invention is conceived to overcome the disadvantages of the conventional epoxy resin based adhesives. An object of the present invention is to provide a novel adhesive composition having improved adhesive force and peeling strength at low temperature.

Another object of the present invention is to provide an adhesive composition having greatly improved adhesiveness between SMC material and wood or PVC material.

### BRIEF DESCRIPTION OF THE DRAWING

The above and other objects, features and advantages of the present invention will become apparent from the following description of a preferred embodiment given in conjunction with the accompanying drawing, in which:

FIG. 1 is a photograph of an SMC board and a PVC core material for a door;

FIG. 2 is a photograph of an SMC board and a PVC core material that are bonded to each other by means of a conventional adhesive;

FIG. 3 is a photograph of an SMC board and a PVC core material that are bonded to each other by means of an adhesive comprising an adhesive composition of the present invention;

FIG. 4a is a graph showing measurement results of peeling strength of Fe boards bonded using a conventional adhesive;

FIG. 4b is a graph showing measurement results of peeling strength of Fe boards bonded using an adhesive comprising an adhesive composition of the present invention;

FIG. 5a is a graph showing measurement results of peeling strength of Al boards bonded using a conventional adhesive; and

FIG. 5b is a graph showing measurement results of peeling strength of Al boards bonded using an adhesive comprising an adhesive composition of the present invention.

### DETAILED DESCRIPTION OF THE PREFERRED EMBODIMENT

An adhesive composition of the present invention comprises an epoxy resin based main adhesive, and a curing agent composed of polymeric amine and amine-terminated reactive rubber.

Although a mixing ratio of the main adhesive component and the curing agent component may be changed depending on usage temperature and environments and the like, it is suitably in a range of 1:2 to 2:1 by weight, preferably 1:1 by weight.

The epoxy resin based main adhesive is composed of 50 to 100% by weight of BPA epoxy resin; 0.5 to 5% by weight of a dispersant and 0.5 to 5% by weight of a fluidity adjusting agent as additives; and 0 to 50% by weight of a filler.

The BPA epoxy resin includes general BPA epoxy resin itself, NBR modified BPA epoxy resin, CTBN modified BPA epoxy resin, urethane modified BPA resin, dimer acid modified BPA epoxy resin, and the like.

The curing agent is composed of 15 to 50% by weight of polymeric amine; 1 to 99% by weight of amine-terminated reactive rubber and 0.5 to 5% by weight of an anti-settling agent as additives; 0.1 to 10% by weight of tertiary amine as a catalyst; and 0 to 60% by weight of a filler.

In the present invention, amine-terminated reactive rubber is mixed with the curing agent to impart elasticity to epoxy resin, thereby increasing adhesive force and peeling strength of an adhesive. Particularly, it is possible to eliminate complexity of preparation processes contrary to conventional preparation methods.

Further, it is possible to reduce differences in physical properties between a final material, which is prepared by mixing the epoxy resin based main adhesive component with the curing agent component, and the respective components.

When an adhesive comprising the adhesive composition of the present invention was applied to bonding of an SMC board made of unsaturated polyester and hard foam PVC material and bonding of the SMC board and wood, it was found that the adhesive force was greatly improved, and particularly, the peeling strength was remarkably enhanced. Therefore, it was possible to manufacture a novel door capable of solving heavy weight and a corrosion phenomenon that are disadvantages of conventional steel doors.

In preparing the adhesive composition of the present invention, the respective components are weighted and homogeneously mixed for a proper period of time. In this case, mixing temperature may be consistently maintained at room temperature or increased to a temperature higher than room temperature for facilitation of the mixing, if necessary.

Basic physical properties of the main adhesive component and the curing agent component of the adhesive composition of the present invention were measured. As a result, the following physical properties were found.

First, the main adhesive component represented a viscosity of about 10,000 cps that was measured for 250 g of a sample by a BH viscometer at room temperature (25° C.), and at least 99% by weight of residue solid content that was measured after the sample was maintained for 25 minutes at 150° C.

Meanwhile, the curing agent component represented a viscosity of about 30,000 to 60,000 cps that was measured for 250 g of the sample by the BH viscometer at room temperature (25° C.), and at least 99% by weight of residue solid content that was measured after the sample was maintained for 25 minutes at 150° C.

The composition obtained by mixing the main adhesive component and the curing agent component represented the following physical properties. First, the main adhesive component and the curing agent component were homogeneously mixed in a ratio of 1:1 by weight.

The viscosity of the mixture was measured in the same manner as the respective components. As a result, the mixture represented a viscosity of 15,000 to 30,000 cps. That is, it was found that the viscosity was not greatly changed due to the mixing of the two components.

Then, the curing degree of the mixture was measured for 250 g of a sample at room temperature, based on a period of time for which the viscosity was twice as large as the initial value. As a result, the curing time ranged from 50 to 100 minutes although it depends on whether a season is summer or winter.

Then, the hardness of a final cured body obtained through the curing of the mixture of the two components was measured. The hardness of 5 g of a sample that was maintained for two hours at 60° C. was measured as 50 or higher using a Shore-D type durometer. Thus, it was found that the final cured body had very excellent hardness.

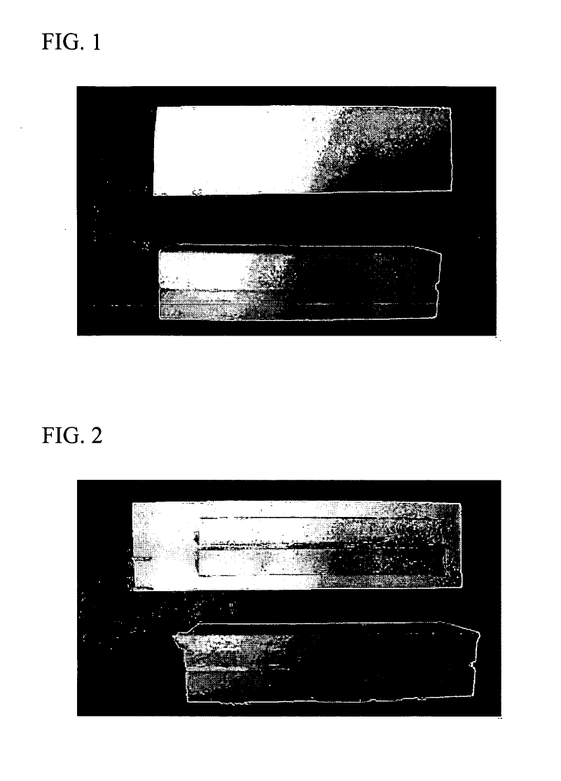

An adhesive comprising the adhesive composition of the present invention having such physical properties was used for bonding of a door constructed of a core made of hard plastic PVC material and an SMC board (see FIG. 1). As a result, it was found that the hardness of the adhesive was very excellent.

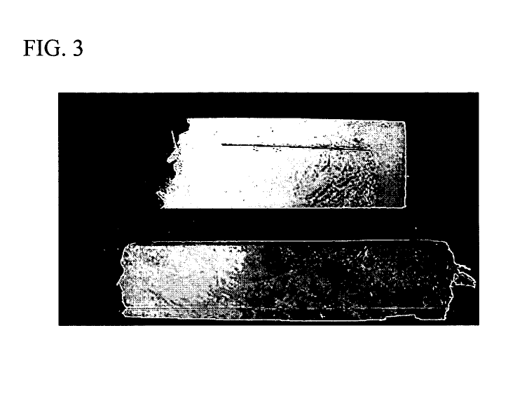

FIG. 2 is a photograph showing the degree of bonding of a door constructed of a core made of PVC material and an SMC board using a conventional BPA epoxy resin adhesive. The figure shows a detached state where the adhesive remains on the board when the bonded core and board are separated from each other by applying external force. Meanwhile, the degree of bonding of a door constructed of a core made of PVC material and an SMC board using the adhesive comprising the adhesive composition of the present invention was evaluated. The core and the board could not be easily separated from each other even though external force was applied thereto since the degree of bonding of them is very high. Finally, as shown in FIG. 3, portions of the core and the board were broken. That is, it can be understood that the adhesive comprising the composition of the present invention has very high adhesive force.

Meanwhile, the following comparative tests were performed to evaluate whether the peeling strength of the adhesive composition of the present invention was improved.

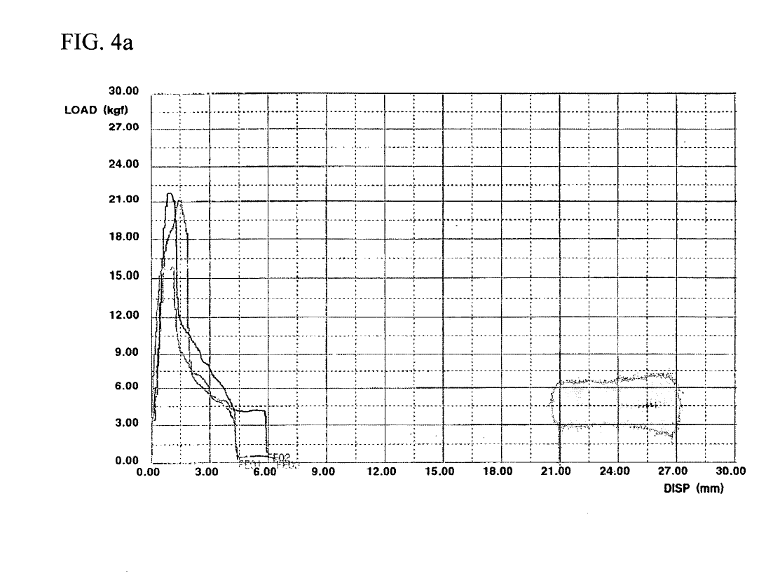

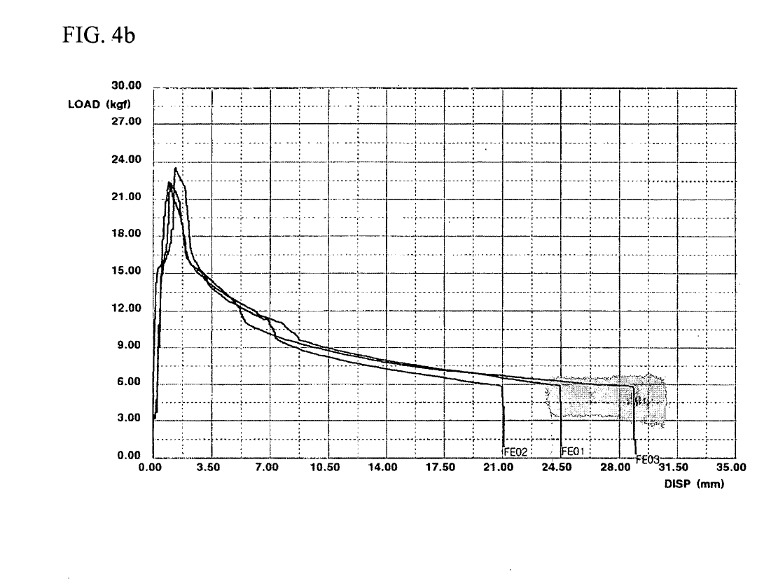

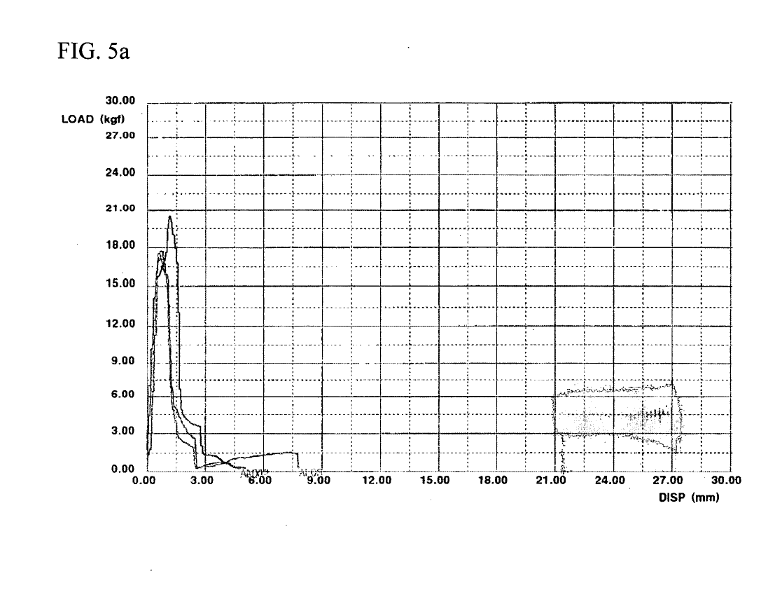

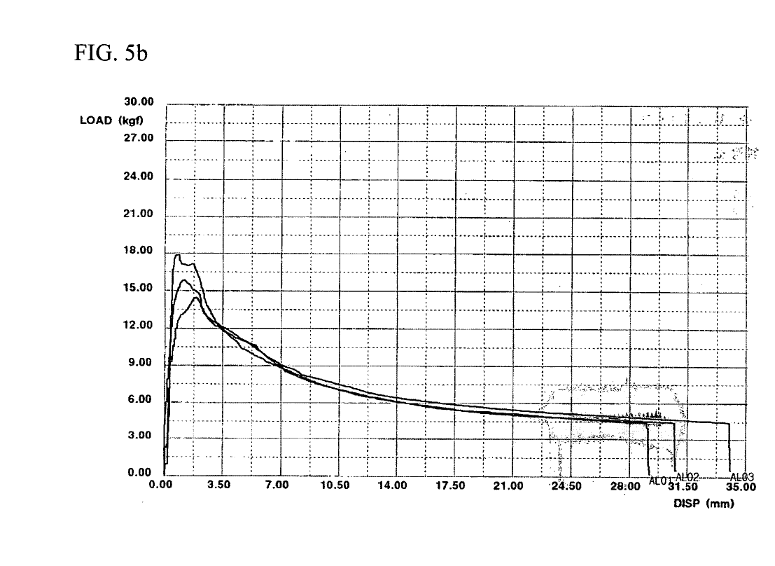

First, the conventional epoxy resin based adhesive and the adhesive comprising the composition of the present invention were used to bond metal boards. Then, the peelability thereof was tested. Tested samples were steel boards (Fe/Fe) and aluminum boards (Al/Al). Comparative results of the peeling strength for the Fe boards are shown in FIG. 4a (the conventional adhesive) and FIG. 4b (the adhesive of the present invention). Comparative results of the peeling strength for the Al boards are shown in FIG. 5a (the conventional adhesive) and 5b (the adhesive of the present invention).

It can be understood from these figures that the composition of the present invention has greatly improved peeling strength.

As can be seen from the aforementioned results, the final cured body of the adhesive of the present invention has elasticity while keeping its hardness due to the use of amine-terminated reactive rubber and accordingly has a property capable of greatly reinforcing impact strength.

As described above, a general epoxy based adhesive has low adhesive force for hard plastics, whereas an adhesive comprising the adhesive composition of the present invention has superior adhesive force for SMC boards, PVC cores or wood due to reactive rubber included therein.

Further, a final cured body of the general epoxy based adhesive has a disadvantage in that the brittleness thereof becomes higher at low temperature and thus may be easily broken even with small impact at low temperature. On the contrary, the adhesive comprising the adhesive composition of the present invention has constant adhesiveness regardless of usage temperature since the reactive rubber reinforces the brittleness of the final cured body at low temperature.

With the use of the adhesive comprising the adhesive composition of the present invention, it is possible to improve the durability of a novel door made of new materials, particularly composites of SMC, PVC and wood materials, compared with a conventional door made of only steel or wood.

1. An adhesive composition, comprising:
a main adhesive composed of 50 to 100% by weight of BPA epoxy resin, 0.5 to 5% by weight of a dispersant and 0.5 to 5% by weight of a fluidity adjusting agent as additives, and 0 to 50% by weight of a filler; and
a curing agent composed of 15 to 50% by weight of polymeric amine, 1 to 99% by weight of amine-terminated reactive rubber and 0.5 to 5% by weight of an anti-settling agent as additives, 0.1 to 10% by weight of tertiary amine as a catalyst, and 0 to 60% by weight of a filler,
wherein the main adhesive component and the curing agent component are mixed in a ratio of 1:2 to 2:1 by weight.

2. The adhesive composition as claimed in claim 1, wherein the main adhesive component has a viscosity of 10,000 cps and the curing agent component has a viscosity of 30,000 to 60,000 cps.

3. The adhesive composition as claimed in claim 1, wherein a cured body of a mixture of the main adhesive component and the curing agent has a viscosity of 15,000 to 30,000 cps.

4. The adhesive composition as claimed in claim 3, wherein the hardness of the cured body is 50 or higher with a shore-D type durometer.
